(19) United States
(12) Patent Application Publication
(10) Pub. No.: US 2009/0123679 A1
(43) Pub. Date: May 14, 2009

(54) PRINTED WATER SOLUBLE FILM WITH DESIRED DISSOLUTION PROPERTIES

(76) Inventors: Frank William Denome, Cincinnati, OH (US); Xavier Trawka, Ath (BE)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/270,547

(22) Filed: Nov. 13, 2008

Related U.S. Application Data
(60) Provisional application No. 61/002,955, filed on Nov. 13, 2007.

(51) Int. Cl. B32B 1/08; B32B 5/00

(52) U.S. Cl. 428/35.2; 428/195.1

(57) ABSTRACT

A printed water soluble material having desired dissolution properties and pouches formed of the printed water soluble material containing a cleaning composition.

### CROSS REFERENCE TO RELATED APPLICATION

The present application claims priority to U.S. Provisional Application Ser. No. 61/002,955, filed Nov. 13, 2007.

### FIELD OF THE INVENTION

The present invention relates to water soluble material wherein graphics are printed onto the film leaving the water soluble material with desired dissolution properties and opacity properties after rubbing the printed water soluble material.

### BACKGROUND OF THE INVENTION

Printing onto water soluble films is also known. METHOD® automatic dishwashing unitized dose products having an ordered repeating pattern of white or gray trademarked symbols printed onto the water soluble film.

WO 2007034471 A3 relates to a water-soluble detergent printed film comprising a film support and at least one print, being printed thereon and/or therein said film, said film is a water-soluble detergent adapted for effective cleansing of various human body and goods cleaning. WO 2007034471 also discusses a method of producing a water-soluble detergent printed film, comprising forming a detergent film; and, printing the same with at least one print. U.S. Pat. No. 5,666,785 relates to printing directly on water soluble film and more particularly to a method and apparatus for printing graphics and text directly on water soluble films while the film is in the process of being formed into a water soluble container by a packaging machine. JP 55-034966 relates to print on fruits with distortionless impressions without causing damage to them, by printing on water-soluble film, pasting the film on fruits by using adhesive, and then removing the film by dissolution.

Over print varnishes have been utilized over inks and printed paper and printed water insoluble polyolefin films, especially in the food packaging industry. The purpose of the over print varnish is often to stabilize the ink or to provide some water-resistance to the printed substrate. See U.S. Pat. No. 4,170,681, U.S. Pat. No. 4,830,902 and U.S. Pat. No. 5,766,732.

Using over print vanish on water soluble film has also been discussed in WO 06/124484 to improve storage stability, in particular in a high-humidity environment and/or the feel to the touch.

However it has been found that certain properties of the water soluble material are affected by use of inks, pigmented and unpigmented (white), and optionally overprint varnish. One issue being that the water soluble material having inks with or without over print varnished applied thereto and then placed on a roll for storage, results in blocking issues where the water soluble material will adhere to itself and cannot be removed from the roll easily or without damage to the material. Another issue is the solubility of the water soluble material is impacted negatively by inks with over print varnish either because of the solubility of the over print varnish or due to cross-linking of the over print varnish over time. Another issue is the strength of the ink to remain on the surface of the water soluble material if a force, such as rubbing, is applied.

### SUMMARY OF THE INVENTION

A printed water soluble material comprising a water soluble material; an ink on the surface of the water soluble material; wherein the printed water soluble material has a dissolution index less than 1.5.

### DETAILED DESCRIPTION OF THE INVENTION

It has been found that selected ink properties eliminate the undesired affects upon the solubility of the water soluble material and strength of adhesion of the ink to the water soluble material. There is also a benefit achieved for the blocking issues of the water soluble material.

### Ink

The inks appropriate for the present application must be suitable for printing onto water soluble film and for the resulting film to have the desired properties of dissolution index, opacity index and blocking grade. The ink itself should also provide a desired dispersion grade in water.

The ink is selected from white, red, blue, yellow, green, pink, purple, orange, black, gray, pink and mixtures thereof. In one embodiment, if the ink is selected as a color other than white, an over print varnish is on the surface of the water soluble material. Preferred methods for printing on the above-mentioned films include but are not limited to those described in U.S. Pat. No. 5,666,785 and WO 06/124484. Printing is usually done with inks and dyes and used to impart patterns and colors onto a water-soluble film. Any kind of printing can be used, including rotogravure, lithography, flexography, porous and screen printing, inkjet printing, letterpress, tampography and combinations thereof. Preferred for use herein is flexography printing. Flexography is a printing technology which uses flexible raised rubber or photopolymer plates to carry the printing solution to a given substrate.

Standard line dryer boxes with blown air (195-200° F.) can be used to dry any printed water soluble material.

### Dispersion Grade

As used herein, the “dispersion grade” is a grading scale used to rank the behavior of the ink after the water soluble material on which it is printed, dissolves. A grade of 1 for the Dispersion Grade correlates to an ink that fully disperses in water during the Dissolution Test Method below. A grade of 2 the Dispersion Grade correlates to that ink somewhat dispersed, small size pieces (less than or equal to about 1 mm) present in water during the Dissolution Test Method below. A grade of 3 the Dispersion Grade correlates to ink present in large pieces (greater than about 1 mm) in the water during the Dissolution Test Method.

The Dispersion Grade should be less than 2 for the ink of the present application. The Dispersion Grade should be 1 for the ink of the present application.

### Dissolution Index

The Dissolution Index as used herein relates to a comparison value between a water soluble material without any ink or overprint varnish compared to a printed water soluble material, where both water soluble materials have the same thickness. The Dissolution Index for the printed water soluble film for the present application should be less than 1.5, preferably less than 1.3.

### Opacity Index

As used herein, the “Opacity Index” is an index relating to the strength the ink has adhering to the water soluble material surface. The opacity is measured for the printed water soluble material before a rubbing test is run and then the opacity is measured again after a rubbing test is employed. Opacity Index needs to be >0.85

### ASTM Designation D 5264 Standard Test Method

Print at least one rectangular block of at least 4 in×6 in of ink onto the water soluble material. Precondition the sets of printed water soluble material samples for a minimum of 2 hours at 75°+/−5° F. Actual relative humidity of this environment should be between 45% and 50%. Samples should be separated sufficiently so both sides of the sample is equilibrated at this condition.

Place the printed water soluble material sample being tested on the flat surface of the Sutherland machine base. Using masking tape to hold the sample in place and flat as it has a tendency to curl.

Using a 1 ml syringe, place 0.2 ml of the liquid having the formulation shown in Table 1 onto the secured printed water soluble material sample in a sinusoidal wave on top of the printed block.

Cut a Buehler microcloth (8″×2½″) and attach to the 4 lbs. metal block. Set dial indicator for the desired number of strokes. 20 cycles should be used

TABLE 1

| Material | Parts (%) |
|---|---|
| Glycerine | 2.48 |
| Neodol C11 E9¹ | 2.63 |
| SLF-18² | 44.69 |
| Dipropylene Glycerol | 41.84 |
| Water | 7.55 |

¹nonionic surfactant of carbon chain length 11 and an ethoxylation level of 9.
²Surfactant

### Blocking Grade

The Blocking Grade as used herein relates to the ease in which a roll of printed water soluble material can be unwound without issue. Blocking can take the form of sticking layers of the printed water soluble material to itself resulting in deformation or tearing of the material or resistance of the film to removal from the roll, removal of ink from the water soluble material surface and audio indication of sticking or adherence of the printed water soluble material to itself, similar in sound to a whisper or the opening sound of the hook and loop closure material sold as VELCRO®.

### Blocking Grade Testing

Take a roll length of greater than or equal to about 100 meters of printed water soluble material. Place a roll with printed surface facing out on the roll out on a suitable unwind stand. Holding the film web on both sides, slowly unwind (about 1.2 m/second) the web while monitoring the sound and appearance of the roll at the point of separation between the film layer being removed and the film layers remaining on the roll. “Blocking” can be evaluated at any point throughout the roll however, for the purpose of testing, the evaluation will be noted and documented at a point approximately 15.24 m (50 ft.) into the roll.

### Grading Scale

Grade 1: No Blocking—no blocking, no audio indication at the point of unwind.

Grade 2: Slight Blocking—slight resistance/audio indication with no ink transfer at the point of unwind.

Grade 3: Moderate Blocking—moderate resistance to unwinding & audio indication at the point of unwind with spots (2-3 mm) of ink and/or pattern removal/transfer at the point of unwind.

Grade 4: Strong Blocking—strong resistance to unwinding & audio indication at the point of unwind with greater than about 3 mm of ink and/or pattern removal/transfer

Grade 5: Severe Blocking—material will not unwind without deformation or tearing of the material at the point of unwind.

The Blocking Grade of the present application is less than or equal to 2. Preferably, the Blocking Grade is less than 2.

### Over Print Varnish

The over print varnishes appropriate for the present application must be suitable for printing onto water soluble film and for the resulting film to have the desired properties of dissolution index, opacity index and blocking grade. The over print varnish itself should also provide a desired dispersion grade in water. Preferably over print varnish compositions should be the same binding composition utilized for the ink, but without the pigment added. The over print varnish may be placed on the surface of the water soluble material. In one embodiment, the ink is located between the water soluble material and the over print varnish.

### Water Soluble Material

As used herein “water soluble” means a film that is dissolves under the water soluble test method below at 20° C. within 90 seconds. A detailed discussion of the test method to obtain dissolution information can be found in U.S. Pat. No. 6,787,512 B1.

For the Dissolution Test Method below the water soluble material must be aged for 24 hours at 70° F. (+/−1.5° F.) and 50% relative humidity (+/−1.5% relative humidity) by being exposed without being covered or otherwise protected from the temperature and humidity.

### Dissolution Test Method

Cut three test specimens from film sample to a size of 3.8 cm×3.2 cm. If cut from a film web, specimens should be cut from areas of web evenly spaced along the transverse direction of the web. Lock each specimen in a separate 35 mm slide mount. Fill beaker with 500 mL of distilled water. Measure water temperature with thermometer and, if necessary, heat or cool water to maintain temperature at 20° C. (about 68° F.). Mark height of column of water. Place magnetic stirrer on base of holder. Place beaker on magnetic stirrer, add magnetic stirring rod to beaker, turn on stirrer, and adjust stir speed until a vortex develops which is approximately one-fifth the height of the water column. Mark depth of vortex.

Secure the 35 mm slide mount in an alligator clamp of a slide mount holder such that the long end of the slide mount is parallel to the water surface. The depth adjuster of the holder should be set so that when dropped, the end of the clamp will be 0.6 cm below the surface of the water. One of the short sides of the slide mount should be next to the side of the beaker with the other positioned directly over the center of the stirring rod such that the film surface is perpendicular to the flow of the water.

In one motion, drop the secured slide and clamp into the water and start the timer. Disintegration occurs when the film breaks apart. When all visible film is released from the slide mount, raise the slide out of the water while continuing to monitor the solution for undissolved film fragments. Dissolution occurs when all film fragments are no longer visible and the solution becomes clear.

Record the individual and average disintegration and dissolution times and water temperature at which the samples were tested.

Preferred water soluble materials are polymeric materials, preferably polymers which are formed into a film or sheet. The water soluble material can, for example, be obtained by casting, blow-molding, extrusion or blown extrusion of the polymeric material, as known in the art.

Preferred polymers, copolymers or derivatives thereof suitable for use as water soluble material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the water soluble material, for example a PVA polymer, is at least 60%.

The polymer can have any weight average molecular weight, preferably from about 1000 to 1,000,000, more preferably from about 10,000 to 300,000 yet more preferably from about 20,000 to 150,000.

Mixtures of polymers can also be used as the water soluble material. This can be beneficial to control the mechanical and/or dissolution properties of the compartments or water soluble material, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000.

Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol.

Preferred for use herein are polymers which are from about 60% to about 98% hydrolysed, preferably about 80% to about 90% hydrolysed, to improve the dissolution characteristics of the material.

Most preferred water soluble materials are PVA films known under the trade reference Monosol M8630, as sold by MonoSol LLC of Gary, Ind., US, and PVA films of corresponding solubility and deformability characteristics. Other films suitable for use herein include films known under the trade reference PT film or the K-series of films supplied by Aicello, or VF-HP film supplied by Kuraray.

The water soluble material herein can also comprise one or more additive ingredients. For example, it can be beneficial to add plasticisers, for example glycerol, ethylene glycol, diethyleneglycol, propylene glycol, sorbitol and mixtures thereof. Other additives include functional detergent additives to be delivered to the wash water, for example organic polymeric dispersants, etc.

| | | Dissolution Test⁸ | | | | | | | | | |
|---|---|---|---|---|---|---|---|---|---|---|---|
| | | | Average | | | | | | | | |
| | | Water | Time | | Opacity⁷ | | | | | | |
| | Film | Temp | (seconds)² | | Pre- | Post- | Rupture | Dissolution | Dispersion | Blocking | Opacity |
| Ink | Ref¹ | (° C.) | Rupture | Dissolution | Rub | Rub | Index³ | Index³ | Grade⁴ | Grade⁵ | Index⁶ |
| None, | 102080907- | 20.4 | 18.3 | 50.0 | na | na | Basis | Basis | Basis | na | na |
| Control | 017(D) | | | | | | | | | | |
| Sun | ITT0158- | 20.4 | 18.3 | 180.0 | 37.1 | 14.2 | 1.00 | 3.60 | 3 | 1 | 0.38 |
| Chemical | 17- | | | | | | | | | | |
| White | 101 | | | | | | | | | | |
| GCNFW1 | | | | | | | | | | | |
| 094867 | | | | | | | | | | | |
| Sun | ITT0158- | 20.4 | 17.7 | 50.7 | 54.7 | 49.7 | 0.96 | 1.01 | 1 | 1 | 0.91 |
| Chemical | 17- | | | | | | | | | | |
| Aquadestruct | 102 | | | | | | | | | | |
| White | | | | | | | | | | | |
| CRPFW16 | | | | | | | | | | | |
| 11830- | | | | | | | | | | | |
| MOD | | | | | | | | | | | |
| Sun | ITT0158- | 20.4 | 18.0 | 48.0 | 52.8 | 53.9 | 0.98 | 0.96 | 1 | 1 | 1.02 |
| Chemical | 17- | | | | | | | | | | |
| Aquadestruct | 103 | | | | | | | | | | |
| White | | | | | | | | | | | |
| CRPFW16 | | | | | | | | | | | |
| 11830 | | | | | | | | | | | |
| Environmental | ITT0158- | 20.4 | 18.7 | 180.0 | 60.8 | 37.9 | 1.02 | 3.60 | 2 | 4 | 0.62 |
| Inks | 17- | | | | | | | | | | |
| Aqua Poly | 104 | | | | | | | | | | |
| Super | | | | | | | | | | | |
| Opaque | | | | | | | | | | | |
| White | | | | | | | | | | | |
| QW000046 | | | | | | | | | | | |
| Environmental | ITT0158- | 20.4 | 18.3 | 180.0 | 62.3 | 35.6 | 1.00 | 3.60 | 3 | 4 | 0.57 |
| Inks | 17- | | | | | | | | | | |
| Film III | 105 | | | | | | | | | | |
| Opaque | | | | | | | | | | | |
| White FR | | | | | | | | | | | |
| EC007094 | | | | | | | | | | | |
| Environmental | ITT0158- | 20.4 | 18.3 | 71.3 | 48.0 | 24.4 | 1.00 | 1.43 | 1 | 3 | 0.51 |
| Inks | 17- | | | | | | | | | | |
| Stable | 106 | | | | | | | | | | |
| Flex ES | | | | | | | | | | | |
| Opaque | | | | | | | | | | | |
| White | | | | | | | | | | | |
| SFX02700 | | | | | | | | | | | |
| Environmental | ITT0158- | 20.4 | 17.7 | 49.7 | 41.5 | 26.9 | 0.96 | 0.99 | 1 | 3 | 0.65 |
| Inks | 17- | | | | | | | | | | |
| Plus 0700 | 107 | | | | | | | | | | |
| Pro Plus | | | | | | | | | | | |
| Opaque | | | | | | | | | | | |
| White | | | | | | | | | | | |
| Plus0700 | | | | | | | | | | | |
| Water Ink | ITT0158- | 20.4 | 19.0 | 82.3 | 57.2 | 39.3 | 1.04 | 1.65 | 1 | 2 | 0.69 |
| Technologies | 17- | | | | | | | | | | |
| Incorporated | 109 | | | | | | | | | | |
| Opta | | | | | | | | | | | |
| Film OPQ | | | | | | | | | | | |
| White | | | | | | | | | | | |
| W0L009656 | | | | | | | | | | | |

Notes
¹Base film is M8630 @ 3 mil (76 microns) thick
²n = 3, test is stopped after 180 seconds/3 minutes
³Index = (Rupture for Test Film/Rupture for Basis Film), same for Dissolution; Rupture &Dissolution Index needs to be <1.5
⁴Dispersion grade needs to be <2
⁵Blocking Grade needs to be </=2
⁶Index = (Post-Rub/Pre- Rub); Opacity Index needs to be >0.85
⁷Pre- Rub, n = 5; Post-Rub, n = 3
⁸As outlined in U.S. Pat. No. 6,787,512 B1 except water temperature is 20.4° C.

The printed water soluble material may be formed into a pouch or a unit dose container. The contents of the pouch or unit dose container may include liquids, gels, solids, powders or gasses. The liquids, gels, pastes, solids and powders may comprise detergents. The gas may be included either deliberately, accidentally, as inevitable result of a manufacturing process or be released from one or more of the contents of one or more of the compartments.

### Powder Detergent

Powder detergent is herein understood to typically include any detergent in solid form, particularly including powders, granular, spray-dried, agglomerated and compacted detergent compositions and combinations thereof. Preferably, the powder detergent will comprise at least one detergent adjunct selected from the group consisting of builders, chelants, enzymes, bleaches, bleach activators, bleach catalysts, metal protectors, surfactants, glass protectors, soil release polymers, perfumes and anti-scalants and combinations thereof. Preferably the powder is white in color, but may contained colored particles making up less then 50 vol % of the powder detergent, preferably between 0.01 vol % and 50 vol % by volume of the unit dose compartment containing the powder detergent.

### Liquid Portion

The liquid portion of the contents encompasses liquids, gels and pastes. The liquid portion may comprise some water, but as it will be contained by a water soluble material, the level of water should be restricted to less than 10% free water, preferably less than 8% free water by weight of the liquid portion. Liquid portion may also contain quantities of low molecular weight primary or secondary alcohols such as methanol, ethanol, propanol and isopropanol can be used in the liquid detergent of the present invention. Other suitable carrier solvents used includes glycerol, propylene glycol, ethylene glycol, 1,2-propanediol, sorbitol, dipropylene glycol and mixtures thereof.

### Organic Solvent

In certain embodiments the liquid portion may comprise an organic solvent. The organic solvents should be selected so as to be compatible with the targeted surfaces for cleaning such as fabrics or tableware/cookware as well as being compatible with the different parts of a machine used to clean such surfaces such as a laundry washing machine or an automatic dishwashing machine. Furthermore, the solvent system should be effective and safe to use having a volatile organic content above 1 mm Hg (and preferably above 0.1 mm Hg) of less than about 50%, preferably less than about 30%, more preferably less than about 10% by weight of the solvent system. Also they should have very mild pleasant odors. The individual organic solvents used herein generally have a boiling point above about 150° C., flash point above about 100° C. and vapor pressure below about 0.133 Pascal (1 mm Hg), preferably below 0.0133 Pascal (0.1 mm Hg) at 25° C. and atmospheric pressure.

Solvents that can be used herein include: i) alcohols, such as benzyl alcohol, 1,4-cyclohexanedimethanol, 2-ethyl-1-hexanol, furfuryl alcohol, 1,2-hexanediol and other similar materials; ii) amines, such as alkanolamines (e.g. primary alkanolamines: monoethanolamine, monoisopropanolamine, diethylethanolamine, ethyl diethanolamine; secondary alkanolamines: diethanolamine, diisopropanolamine, 2-(methylamino)ethanol; ternary alkanolamines: triethanolamine, triisopropanolamine); alkylamines (e.g. primary alkylamines: monomethylamine, monoethylamine, monopropylamine, monobutylamine, monopentylamine, cyclohexylamine), secondary alkylamines: (dimethylamine), alkylene amines (primary alkylene amines: ethylenediamine, propylenediamine) and other similar materials; iii) esters, such as ethyl lactate, methyl ester, ethyl acetoacetate, ethylene glycol monobutyl ether acetate, diethylene glycol monoethyl ether acetate, diethylene glycol monobutyl ether acetate and other similar materials; iv) glycol ethers, such as ethylene glycol monobutyl ether, diethylene glycol monobutyl ether, ethylene glycol monomethyl ether, ethylene glycol monoethyl ether, diethylene glycol monomethyl ether, diethylene glycol monoethyl ether, propylene glycol butyl ether and other similar materials; v) glycols, such as propylene glycol, diethylene glycol, hexylene glycol (2-methyl-2,4 pentanediol), triethylene glycol, composition and dipropylene glycol and other similar materials; and mixtures thereof.

### Surfactant

Surfactants suitable herein include anionic surfactants such as alkyl sulfates, alkyl ether sulfates, alkyl benzene sulfonates, alkyl glyceryl sulfonates, alkyl and alkenyl sulphonates, alkyl ethoxy carboxylates, N-acyl sarcosinates, N-acyl taurates and alkyl succinates and sulfosuccinates, wherein the alkyl, alkenyl or acyl moiety is C₅-C₂₀, preferably C₁₀-C₁₈ linear or branched; cationic surfactants such as chlorine esters (U.S. Pat. No. 4,228,042, U.S. Pat. No. 4,239,660 and U.S. Pat. No. 4,260,529) and mono C₆-C₁₆N-alkyl or alkenyl ammonium surfactants wherein the remaining N positions are substituted by methyl, hydroxyethyl or hydroxypropyl groups; low and high cloud point nonionic surfactants and mixtures thereof including nonionic alkoxylated surfactants (especially ethoxylates derived from C₆-C₁₈ primary alcohols), ethoxylated-propoxylated alcohols (e.g., BASF POLY-TERGENT® SLF18), epoxy-capped poly(oxyalkylated) alcohols (e.g., BASF POLY-TERGENT® SLF18B—see WO-A-94/22800), ether-capped poly(oxyalkylated) alcohol surfactants, and block polyoxyethylene-polyoxypropylene polymeric compounds such as PLURONIC®, REVERSED PLURONIC®, and TETRONIC® by the BASF-Wyandotte Corp., Wyandotte, Mich.; amphoteric surfactants such as the C₁₂-C₂₀ alkyl amine oxides (preferred amine oxides for use herein include C₁₂ lauryldimethyl amine oxide, C₁₄ and C₁₆ hexadecyl dimethyl amine oxide), and alkyl amphocarboxylic surfactants such as MIRANOL™ C2M; and zwitterionic surfactants such as the betaines and sultaines; and mixtures thereof. Surfactants suitable herein are disclosed, for example, in U.S. Pat. No. 3,929,678, U.S. Pat. No. 4,259,217, EP-A-0414 549, WO-A-93/08876 and WO-A-93/08874. Surfactants are typically present at a level of from about 0.2% to about 30% by weight, more preferably from about 0.5% to about 10% by weight, most preferably from about 1% to about 5% by weight of composition.

### Builder

Builders suitable for use herein include water-soluble builders such as citrates, MGDA, GLDA, carbonates and polyphosphates e.g. sodium tripolyphosphate and sodium tripolyphosphate hexahydrate, potassium tripolyphosphate and mixed sodium and potassium tripolyphosphate salts; and partially water-soluble or insoluble builders such as crystalline layered silicates (EP-A-0164514 and EP-A-0293640) and aluminosilicates inclusive of Zeolites A, B, P, X, HS and MAP. The builder is typically present at a level of from about 1% to about 80% by weight, preferably from about 10% to about 70% by weight, most preferably from about 20% to about 60% by weight of composition.

Amorphous sodium silicates having an SiO₂:Na₂O ratio of from 1.8 to 3.0, preferably from 1.8 to 2.4, most preferably 2.0 can also be used herein although highly preferred from the viewpoint of long term storage stability are compositions containing less than about 22%, preferably less than about 15% total (amorphous and crystalline) silicate.

### Enzyme

Enzymes suitable herein include bacterial and fungal cellulases such as Carezyme and Celluzyme (Novo Nordisk A/S); peroxidases; lipases such as Amano-P (Amano Pharmaceutical Co.), M1 LIPASE® and LIPOMAX® (Gist-Brocades) and LIPOLASE® and LIPOLASE ULTRA® (Novo); cutinases; proteases such as ESPERASE®, ALCALASE®, DURAZYM® and SAVINASE® (Novo) and MAXATASE®, MAXACAL®, PROPERASE® and MAXAPEM® (Gist-Brocades); α and β amylases such as PURAFECT OX AM® (Genencor) and TERMAMYL®, BAN®, FUNGAMYL®, DURAMYL®, and NATALASE® (Novo); pectinases; and mixtures thereof. Enzymes are preferably added herein as prills, granulates, or cogranulates at levels typically in the range from about 0.0001% to about 2% pure enzyme by weight of composition.

### Bleaching Agent

Bleaching agents suitable for use herein include chlorine and oxygen bleaches, especially inorganic perhydrate salts such as sodium perborate mono- and tetrahydrates and sodium percarbonate optionally coated to provide controlled rate of release (see, for example, GB-A-1466799 on sulfate/carbonate coatings), preformed organic peroxyacids and mixtures thereof with organic peroxyacid bleach precursors and/or transition metal-containing bleach catalysts (especially manganese or cobalt). Inorganic perhydrate salts are typically incorporated at levels in the range from about 1% to about 40% by weight, preferably from about 2% to about 30% by weight and more preferably from abut 5% to about 25% by weight of composition. Peroxyacid bleach precursors preferred for use herein include precursors of perbenzoic acid and substituted perbenzoic acid; cationic peroxyacid precursors; peracetic acid precursors such as TAED, sodium acetoxybenzene sulfonate and pentaacetylglucose; pemonanoic acid precursors such as sodium 3,5,5-trimethylhexanoyloxybenzene sulfonate (iso-NOBS) and sodium nonanoyloxybenzene sulfonate (NOBS); amide substituted alkyl peroxyacid precursors (EP-A-0170386); and benzoxazin peroxyacid precursors (EP-A-0332294 and EP-A-0482807). Bleach precursors are typically incorporated at levels in the range from about 0.5% to about 25%, preferably from about 1% to about 10% by weight of composition while the preformed organic peroxyacids themselves are typically incorporated at levels in the range from 0.5% to 25% by weight, more preferably from 1% to 10% by weight of composition. Bleach catalysts preferred for use herein include the manganese triazacyclononane and related complexes (U.S. Pat. No. 4,246,612, U.S. Pat. No. 5,227,084); Co, Cu, Mn and Fe bispyridylamine and related complexes (U.S. Pat. No. 5,114,611); and pentamine acetate cobalt(III) and related complexes (U.S. Pat. No. 4,810,410).

### Other Components

Other suitable components herein include organic polymers having dispersant, anti-redeposition, soil release or other detergency properties invention in levels of from about 0.1% to about 30%, preferably from about 0.5% to about 15%, most preferably from about 1% to about 10% by weight of composition. Preferred anti-redeposition polymers herein include acrylic acid containing polymers such as SOKALAN PA30, PA20, PA15, PA10 and SOKALAN CP10 (BASF GmbH), ACUSOL 45N, 480N, 460N (Rohm and Haas), acrylic acid/maleic acid copolymers such as SOKALAN CP5 and acrylic/methacrylic copolymers. Preferred soil release polymers herein include alkyl and hydroxyalkyl celluloses (U.S. Pat. No. 4,000,093), polyoxyethylenes, polyoxypropylenes and copolymers thereof, and nonionic and anionic polymers based on terephthalate esters of ethylene glycol, propylene glycol and mixtures thereof.

Heavy metal sequestrants and crystal growth inhibitors are suitable for use herein in levels generally from about 0.005% to about 20%, preferably from about 0.1% to about 10%, more preferably from about 0.25% to about 7.5% and most preferably from about 0.5% to about 5% by weight of composition, for example diethylenetriamine penta(methylene phosphonate), ethylenediamine tetra(methylene phosphonate) hexamethylenediamine tetra(methylene phosphonate), ethylene diphosphonate, hydroxy-ethylene-1,1-diphosphonate, nitrilotriacetate, ethylenediaminotetracetate, ethylenediamine-N,N′-disuccinate in their salt and free acid forms.

The compositions herein can contain a corrosion inhibitor such as organic silver coating agents in levels of from about 0.05% to about 10%, preferably from about 0.1% to about 5% by weight of composition (especially paraffins such as WINOG 70 sold by Wintershall, Salzbergen, Germany), nitrogen-containing corrosion inhibitor compounds (for example benzotriazole and benzimadazole—see GB-A-1137741) and Mn(II) compounds, particularly Mn(II) salts of organic ligands in levels of from about 0.005% to about 5%, preferably from about 0.01% to about 1%, more preferably from about 0.02% to about 0.4% by weight of the composition.

Other suitable components herein include water-soluble bismuth compounds such as bismuth acetate and bismuth citrate at levels of from about 0.01% to about 5%, enzyme stabilizers such as calcium ion, boric acid, propylene glycol and chlorine bleach scavengers at levels of from about 0.01% to about 6%, lime soap dispersants (see WO-A-93/08877), suds suppressors (see WO-93/08876 and EP-A-0705324), polymeric dye transfer inhibiting agents, optical brighteners, perfumes, fillers and clay.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A printed water soluble material comprising:
a water soluble material;
an ink on the surface of the water soluble material;
wherein the printed water soluble material has a dissolution index less than 1.5.

2. The printed water soluble material of claim 1 wherein the ink has a dispersion grade of less than 2.

3. The printed water soluble material of claim 1 wherein the printed water soluble material is placed on a roll and has a blocking grade of equal to or less than 2.

4. The printed water soluble material of claim 1 wherein the opacity index is greater than 0.85.

5. The printed water soluble material of claim 1 wherein the water soluble material comprises polyvinyl alcohol.

6. The printed water soluble material of claim 1 wherein the ink is selected from white, red, blue, yellow, green, pink, purple, orange, black, gray, pink and mixtures thereof.

7. The printed water soluble material of claim 1 wherein the printed water soluble material further comprises an over print varnish on the water soluble material such that the ink is between the water soluble material and over print varnish.

8. The printed water soluble material of claim 1 wherein the film is formed into a pouch.

9. The printed water soluble material of claim 8 wherein pouch contains a cleaning composition.

10. The printed water soluble material of claim 8 wherein pouch contains a liquid cleaning composition.
